(19) United States
(12) Patent Application Publication
(10) Pub. No.: US 2020/0342513 A1
(43) Pub. Date: Oct. 29, 2020

(54) PRODUCT TRAY, REFRIGERATOR, AND PRODUCT TRAY SYSTEM

(71) Applicant: SHARP KABUSHIKI KAISHA, Sakai City (JP)

(72) Inventors: HIROSHI HISAHARA, Sakai City (JP); KINYA YAMADE, Sakai City (JP); SEISHIRO OTOGE, Sakai City (JP); MIWA KAMII, Sakai City (JP)

(21) Appl. No.: 16/837,592

(22) Filed: Apr. 1, 2020

(30) Foreign Application Priority Data
Apr. 25, 2019 (JP) 2019-083611

(51) Int. Cl. G06Q 30/06; G05B 15/02; F25D 25/02

(52) U.S. Cl. CPC G06Q 30/0623; F25D 25/021; G05B 15/02

(57) ABSTRACT

A product tray includes: a product holder configured to hold a product; a product sensor configured to detect product information indicating a state of the product held in the product holder; and a communications unit configured to transmit the product information, based on opening and closing of a door of a storage container housing the product tray.

### CROSS-REFERENCE TO RELATED APPLICATION

The present application claims priority from Japanese Application P2019-083611, filed Apr. 25, 2019, the content to which is hereby incorporated by reference into this application.

### BACKGROUND OF THE INVENTION

### 1. Field of the Invention

The present invention relates to a product tray, a refrigerator, and a product tray system.

### 2. Description of the Related Art

Japanese Unexamined Patent Application Publication No. 2003-114075 discloses an example of a communications unit for a product tray provided to a storage container of, for example, a refrigerator.

The communications unit communicates with an external apparatus to output product information.

However, Japanese Unexamined Patent Application Publication No. 2003-114075 cites that the communication with the external apparatus automatically starts when, for example, the product tray comes closer to the refrigerator acting as the storage container. Thus, if the refrigerator and the product tray are in close proximity to each other in such a case where the product tray is stored in the refrigerator, the communication therebetween is always maintained such that the power consumption by the product tray can increase. An aspect of the present invention is intended to provide, for example, a product tray capable of reducing power consumption.

A product tray according to an aspect of the present invention includes: a product holder holding a product; a product sensor detecting product information indicating a state of the product held in the product holder; and a communications unit transmitting the product information, based on opening and closing of a door of a storage container housing the product tray.

### BRIEF DESCRIPTION OF THE DRAWINGS

FIG. 1 illustrates an example of a product tray system according to a first embodiment;

FIG. 2 illustrates an example of a milk tray according to the first embodiment;

FIG. 3 illustrates a cross-sectional view of the milk tray shown in FIG. 2;

FIG. 4 illustrates an example of a functional configuration of a controller of a product tray shown in FIG. 1;

FIG. 5 illustrates an example of a functional configuration of a controller of a terminal apparatus shown in FIG. 1;

FIG. 6 illustrates an example of a flow of processing executed in the milk tray shown in FIG. 1;

FIG. 7 illustrates an example of a flow of processing executed in the terminal apparatus shown in FIG. 1;

FIG. 8 illustrates an example of an egg tray which is a modification of the product tray;

FIG. 9 illustrates a top view of the egg tray shown in FIG. 8;

FIG. 10 illustrates an example of a product tray system according to a second embodiment;

FIG. 11 illustrates an example of a beer tray according to the second embodiment;

FIG. 12 illustrates a cross-sectional view of the beer tray shown in FIG. 11;

FIG. 13 illustrates an example of a power source shown in FIG. 10;

FIG. 14 illustrates an example of a functional configuration of a controller of the beer tray shown in FIG. 10; and

FIG. 15 illustrates an example of a flow of processing executed in the beer tray shown in FIG. 10.

### DETAILED DESCRIPTION OF THE INVENTION

Described below are embodiments of the present invention with reference to the drawings. Note that like reference numerals designate identical or corresponding components throughout the drawings. Hence, the details thereof will not be elaborated upon.

### First Embodiment

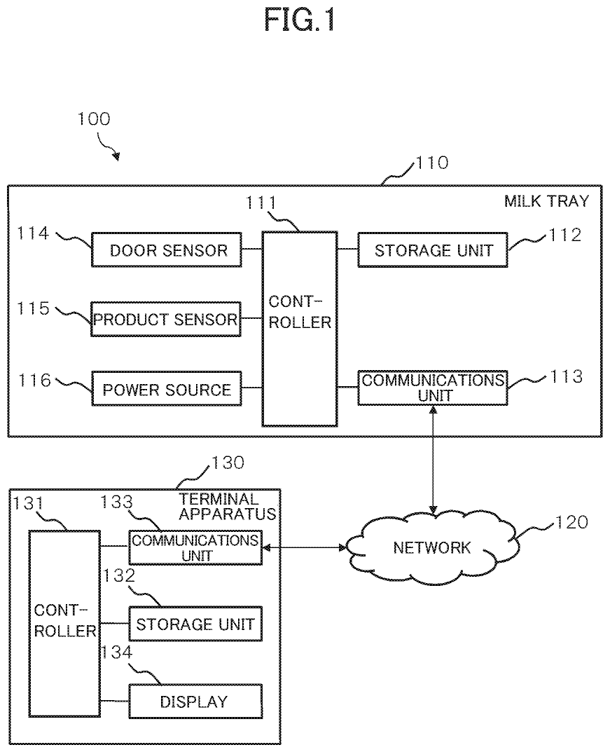

FIG. 1 illustrates an example of a product tray system according this embodiment. Note that, as an example, this embodiment describes the case where a milk tray (a product tray) 110 holding a milk carton (a product 150) is stored in a refrigerator (not shown).

As illustrated in FIG. 1, a product tray system 100 according to this embodiment includes: the milk tray 110; a network 120; and a terminal apparatus 130. The milk tray 110 and the terminal apparatus 130 are connected through the network 120. The milk tray 110 is stored, for example, in a storage container having a door such as a refrigerator, and holds a milk carton; namely, the product 150. In this embodiment, the storage container corresponds to the refrigerator whose inside is cooled. The network 120 corresponds to, for example, the Internet and Bluetooth®. Examples of the terminal apparatus 130 include such devices as smartphones. Note that the milk tray 110 and the terminal apparatus 130 are identified with, for example, an ID. For example, the milk tray 110 is previously registered by a user so that the milk tray 110 is to hold a milk carton. Thus, the milk tray 110 recognizes that the milk tray 110 is to hold a milk carton.

Described next is an example of a main configuration centered on a controller 111 of the milk tray 110 according to this embodiment. The milk tray 110 includes, for example: the controller 111; a storage unit 112; a communications unit 113; a door sensor 114; a product sensor 115; and a power source 116. The controller 111 is, for example, a CPU and an MPU, and executes various kinds of information processing in accordance with a program stored in the storage unit 112. The storage unit 112 is, for example, a flash memory and a RAM, and holds a program executed by the controller 111 and various kinds of data. Moreover, the storage unit 112 acts as a working memory for the controller 111. The communications unit 113 is, for example, an interface, and communicates with the terminal apparatus 130 through the network 120. Note that the milk tray 110 may include, for example, a temperature sensor other than the above components. These components are connected to, and controlled by, the controller 111. Note that the door sensor 114, the product sensor 115, and the power source 116 will be described later.

Described next is an example of a main configuration centered on a controller 131 of the terminal apparatus 130 according to this embodiment. As seen in the milk tray 110, the terminal apparatus 130 includes, for example: a controller 131; a storage unit 132; a communications unit 133; and a display 134. Note that the controller 131, the storage unit 132, and the communications unit 133 are similar in main configuration to those in the milk tray 110. Hence, descriptions thereof shall be omitted. The display 134 displays various kinds of information.

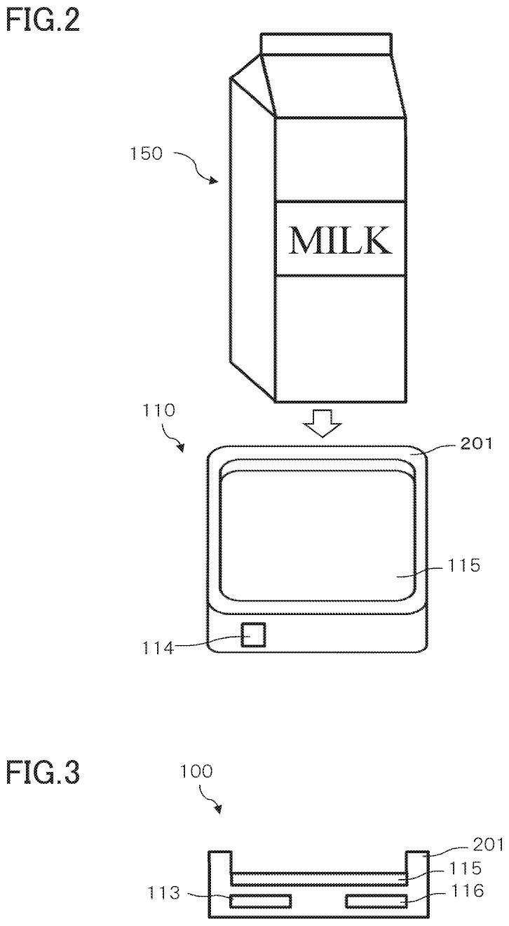

FIG. 2 illustrates a specific example of the milk tray 110. FIG. 3 illustrates a cross-sectional view of a main part of the milk tray 110.

As illustrated in FIGS. 2 and 3, the milk tray 110 according to this embodiment includes: a product holder 201; the communications unit 113; the door sensor 114; the product sensor 115; and the power source 116.

The product holder 201 holds, for example, milk as a product. In this embodiment, for example, a milk carton contained in a paper carton is referred to as milk, The product holder 201 is shaped into, for example, a rectangle whose periphery is provided with a rib to hold the milk carton. Note that this embodiment recites, but not limited to, milk as the product. Alternatively, examples of the product may include: beverages such as soda and beer contained in, for example, bottles, cans and paper cartons; and food such as eggs. Moreover, the product to be held by the product holder 201 may be previously determined by the user registering the product.

The door sensor 114 detects opening and closing of a door of a storage container such as a refrigerator housing the milk tray 110. Examples of the door sensor 114 include an optical sensor, an acceleration sensor, and an atmospheric pressure sensor.

The product sensor 115 detects, for example, whether the product holder 201 holds a milk carton. Examples of the product sensor 115 include a weight sensor and a distance sensor.

The power source 116 supplies power to the components of the milk tray 110. Examples of the power source 116 include a battery and a rechargeable battery.

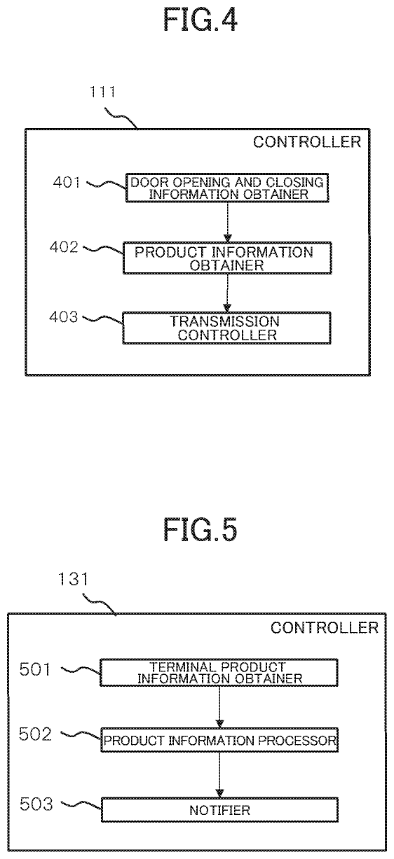

FIG. 4 illustrates an example of a functional configuration of the controller 111 of the milk tray 110 shown in FIG. 1. As illustrated in FIG. 4, the controller 111 according to this embodiment includes, for example: a door opening and closing information obtainer 401; a product information obtainer 402; and a transmission controller 403.

The door opening and closing information obtainer 401 obtains door opening and closing information from, for example, the door sensor 114 provided to the milk tray 110. The door opening and closing information indicates opening and closing of a door of a storage container such as a refrigerator housing the milk tray 110.

For example, the door sensor 114 including an optical sensor outputs: door opening and closing information indicating that the door is open if an amount of light detected by the optical sensor is larger than or equal to a predetermined amount; and door opening and closing information indicating that the door is closed if the amount of light detected by the optical sensor is smaller than the predetermined amount. Note that, for example, an acceleration sensor may be used as the door sensor 114. The door opening and closing information obtainer 401 outputs the door opening and closing information based on a swing detected by the acceleration sensor. Moreover, the door sensor 114 may be of a combination of multiple sensors such as a combined use of an optical sensor and an acceleration sensor. The combination of multiple sensors makes it possible to detect opening and closing of the door more reliably.

The product information obtainer 402 obtains product information based on, for example, the obtained door opening and closing information. The product information indicates a state of the product to be held in the product holder 201. More specifically, the product information obtainer 402 obtains the product information from the product sensor 115, based on, for example, the door opening and closing information. The product information indicates whether the product is held in the product holder 201 of the milk tray 110. For example, when the product sensor 115 is a weight sensor, the product information obtainer 402 obtains: product information indicating that the product is held in the product holder 201 if the weight sensor detects the weight; and product information indicating that the product is not held in the product holder 201 if the weight sensor does not detect the weight. Hence, the product information is obtained based on the door opening and closing information. Such a feature limits the timing of obtaining the product information, making it possible to reduce power to be consumed by the product sensor 115.

Based on, for example, the door opening and closing information, the transmission controller 403 causes the communications unit 113 to transmit the product information obtained by the product information obtainer 402. As can be seen, the product information is transmitted only when the door opening and closing information is output, making it possible to reduce power to be consumed by the communications unit 113. Note that this product information is transmitted to, for example, the terminal apparatus 130. Here, the product information may be directly transmitted to the terminal apparatus 130, or may be transmitted through the network 120, or may be transmitted through a not-shown apparatus such as a server. In particular, when the door is open, the transmission controller 403 causes the communications unit 113 to transmit the product information. In this case, the product tray is not housed in an enclosed space such that the transmission controller 403 has fewer factors in interruption of the communication. Such a feature makes it possible to transmit the product information more reliably. Meanwhile, if the transmission controller 403 causes the communications unit 113 to transmit the product information when the door is closed, it is interpreted that the transmission is made after the work of the user in the storage container. Such a feature makes it possible to transmit newer information on the product.

Furthermore, the product information may include information on a condition of the product such as a weight and a temperature of the product. The weight information on the product can be detected by the weight sensor. Moreover, the temperature of the product can be detected by a temperature sensor included in the product sensor 115, for example.

Note that, for example, the product information detected by the product sensor 115 is stored in the storage unit 112. in this embodiment, the product information is unnecessary after transmitted. Hence, the storage unit 112 does not have to have a large capacity. Instead, the storage unit 112 may, for example, temporarily store the product information, such that the storage unit 112 can be constituted of a simple component configuration.

FIG. 5 illustrates an example of a functional configuration of the controller 131 of the terminal apparatus 130. As illustrated in FIG. 5, the controller 131 according to this embodiment includes, for example: a terminal product information obtainer 501; a product information processor 502; and a notifier 503.

The terminal product information obtainer 501 obtains, for example, the product information. This product information is transmitted, for example, from the milk tray 110. The obtained product information is stored in, for example, the storage unit 132.

Based on the obtained product information, for example, the product information processor 502 updates the product information stored in the storage unit 132. More specifically, the product information processor 502 updates, for example, the product information, on the milk tray 110, previously obtained and stored in the storage unit 132, so that the updated product information includes the newly obtained product information. Moreover, the product information processor 502 may, for example, compare the product information previously obtained with the product information newly obtained by the terminal product information obtainer 501, and obtain information on the comparison (comparison information).

The notifier 503 issues a notice to the user, based on, for example, the product information updated by the product information processor 502. The notice is issued to the display 134 so that the display 134 displays the notice. Moreover, for example, the notifier 503 may cause the display 134 to display the notice, based on the comparison information obtained by the product information processor 502. The notice is displayed based on this comparison information, so that the user is informed of a change in the condition of the product.

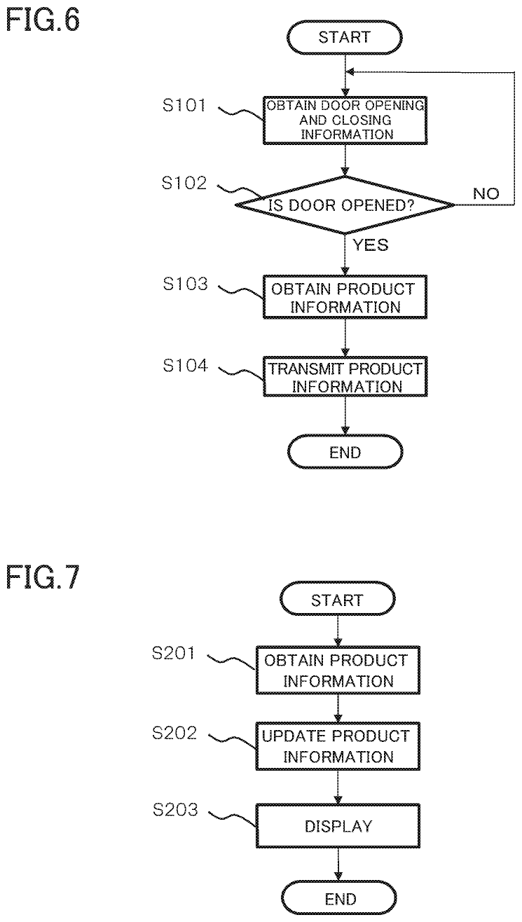

Described next is an example of a flow of processing executed in the milk tray according to this embodiment. FIG. 6 illustrates an example of a flow of processing executed in the milk tray according to this embodiment.

The door opening and closing information obtainer 401 obtains, for example, door opening and closing information on a storage container output by the door sensor 114 (S101). Then, based on the door opening and closing information, the door opening and closing information obtainer 401 determines whether the door of the storage container is opened (S102). If the door is determined to be opened (YES in S102) based on the door opening and closing information, the product information obtainer 402 obtains, for example, product information detected by the product sensor 115 (S103). Then, the transmission controller 403 causes the communications unit 113 to transmit the obtained product information (S104). This product information is transmitted to, for example, an external apparatus such as the terminal apparatus 130. Meanwhile, in S102, if the door opening and closing information obtainer 401 determines that the door is not open (NO in S102), the processing returns to S101. Note that the product sensor 115 may detect the product information when the door is open.

The flow of the processing executed in the milk tray shall not be limited to the above one. Alternatively, various modifications may be possible.

For example, in S102, the door opening and closing information obtainer 401 may determine whether the door is closed. In this case, the product information obtainer 402 (i) proceeds to S103 if the door is determined to be closed, and (ii) returns to S101 if the door is determined not to be closed. As can be seen, the product information is transmitted after the door is closed. Such a feature makes it possible to transmit, for example, the latest product information on the storage container after the user opens the door of the storage container and finishes his or her work. Moreover, the product information may be transmitted in S104 when the door is once determined to be opened in S102 and then closed.

Moreover, in S104, the product information may be transmitted, for example, at intervals of a first predetermined time period (e.g., five seconds) for multiple times. Such a feature makes it possible to compensate for transmission failure of the product information, and transmit the product information more reliably. Moreover, whether or not the door opening and closing information is obtained in S101, the product information detected by the product sensor 115 may be transmitted at intervals of a second predetermined time period (e.g., 30 minutes). In this configuration, the product information is transmitted at intervals of the second predetermined time period longer than the first predetermined time period. Such a feature makes it possible to transmit the latest product information while reducing power consumption.

Described next is an example of a flow of processing executed in the terminal apparatus according to this embodiment. FIG. 7 illustrates an example of a flow of processing executed in the terminal apparatus.

The terminal product information obtainer 501 obtains, for example, product information transmitted from the milk tray 110 (S201).

The product information processor 502 updates, for example, product information stored in the storage unit 132 (S202). More specifically, for example, the product information processor 502 updates the product information previously obtained and stored in the storage unit 132, so that the updated product information includes the newly obtained product information.

Then, the notifier 503 causes, for example, the display 134 to display a notice based on, for example, the updated product information (S203).

Note that the flow of the processing executed in the terminal apparatus 130 shall not be limited to the above one. Alternatively, various modifications may be possible. In S202, for example, the product information processor 502 updates the product information stored in the storage unit 132. Alternatively, for example, the product information processor 502 may compare the previous product information and the obtained product information, and cause the storage unit 132 to store information on the comparison (comparison information) of the products such as an increase or decrease in the product. In S203, based on this comparison information, the notifier 503 may issue a notice. Note that the notice based on the comparison information may be notified, for example, only when a change in the product is observed such as an increase or decrease in the product.

The product tray according to this embodiment transmits the product information to an external apparatus such as the terminal apparatus, based on the information on opening and closing of the door of the storage container. Such a feature makes it possible to transmit the product information less frequently compared with, for example, a case where the product information is transmitted when the communication with the external apparatus is established. As a result, power consumption of the product tray can be reduced. Then, in particular, when the product tray operates on the power of a battery, the battery power to be consumed is reduced, contributing to delaying the time to replace the battery.

Note that, in this embodiment, the controller in the terminal apparatus executes various kinds of processing on the information transmitted from the product tray. The processing may be executed by, for example, another controller included in such a communicable external apparatus as a refrigerator and a server. For example, the terminal apparatus is replaced with a storage container such as a refrigerator, and the refrigerator includes a display to present the product information. Such a feature makes it possible to notify the user of the condition of the product stored in the refrigerator.

Moreover, for example, the product information from the product tray may be transmitted through a communications unit, provided to a storage container such as a refrigerator, to an external apparatus such as a terminal apparatus. Such a feature makes it possible to decrease a communication distance from the product tray, and transmit the product information more reliably.

Moreover, the product tray may further include a battery level detector detecting a battery level of a battery acting as the power source 116. Then, the battery level detected by the battery level detector may be transmitted from the product tray together with the product information. Hence, for example, the display 134 of the terminal apparatus 130 can display the battery level, making it possible to notify the user of the time to replace the battery of the product tray.

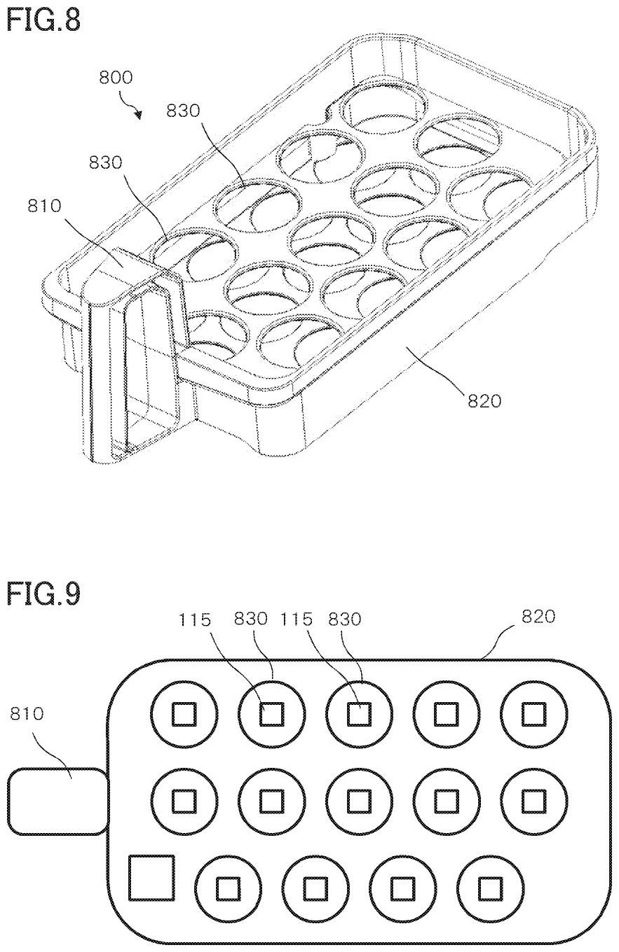

Furthermore, for example, as a modification, the product tray may be an egg tray. FIG. 8 illustrates a perspective view showing an example of an egg tray 800. FIG. 9 illustrates a top view of the egg tray 800.

The egg tray 800 according to this modification includes: a handle 810; a product holder 820 having multiple holes 830; and multiple product sensors 115 each corresponding to one of the holes 830. Other than the above components, the egg tray 800 includes such components as the door sensor 114, the communications unit 113, and the storage unit 112. These components are, similar in configuration to those of the milk tray 110, and the descriptions thereof shall be omitted. This configuration makes it possible to count the number of eggs held in the egg tray 800. Then, for example, such data as the counted number of eggs can be notified to the user. Moreover, for example, if the number of held eggs is smaller than or equal to a predetermined threshold, a display such as a terminal apparatus may notify the user that fewer eggs are available. Such a feature allows the user to understand the necessity to purchase eggs, improving convenience for the user.

In addition, the handle 810 of the egg tray 800 may include a generator to generate power when a button is pressed. For example, the product information is transmitted from the egg tray 800 on the power generated when the user presses the button. Such a feature makes it possible to save the power of the battery in the egg tray 800, and transmit the product information with the user's intension.

The present invention shall not be limited to the above embodiment. The configurations of the above embodiment may be replaced with substantially the same configuration; that is, the same advantageous effects or the intention to achieve.

### Second Embodiment

Described next is a second embodiment of the present invention. Note that descriptions of features similar to those in e first embodiment shall be omitted.

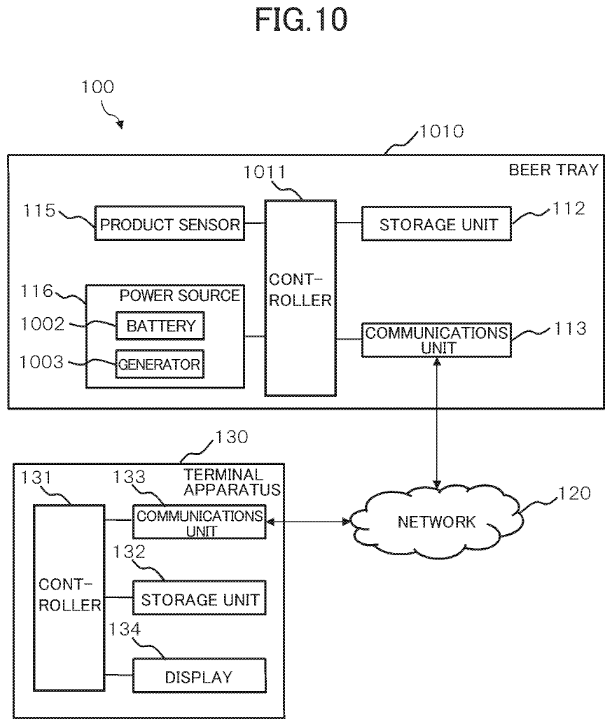

FIG. 10 illustrates an example of a product tray system according to this embodiment. Note that, as an example, this embodiment describes the case where a beer tray (a product tray) 1010 holding a beer (a product) is stored in a refrigerator (not shown).

As illustrated in FIG. 10, the product tray system 100 according to this embodiment is that of the first embodiment whose milk tray 110 is replaced with the beer tray 1010. The network 120 and the terminal apparatus 130 are the same as those in the first embodiment, and the descriptions thereof shall be omitted.

Described next is an example of a main configuration centered on a controller 1011 of the beer tray 1010 according to this embodiment. The beer tray 1010 includes, for example: a controller 1011; the storage unit 112; the communications unit 113; the product sensor 115; and the power source 116. Moreover, the power source 116 includes, for example: a battery 1002; and a generator 1003. Such components as the controller 1011, the storage unit 112, the communications unit 113, and the product sensor 115 are similar to those in the first embodiment, and the descriptions thereof shall be omitted.

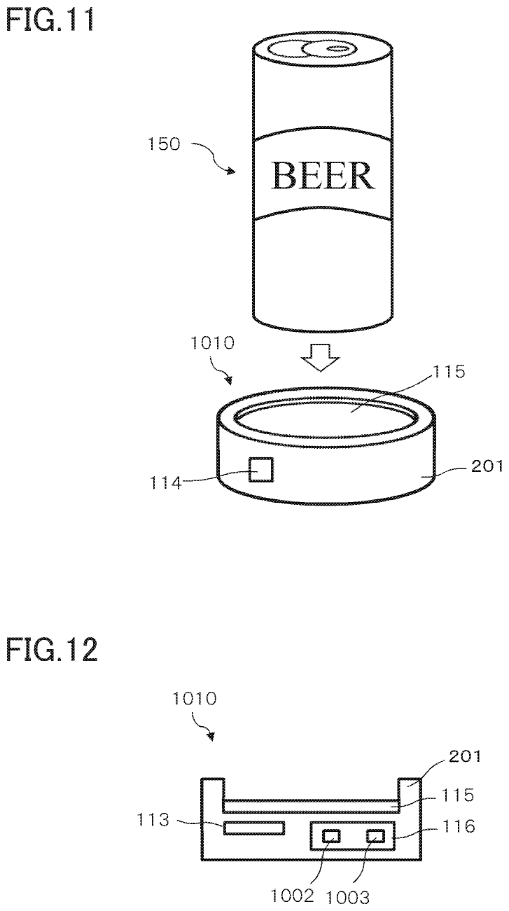

FIG. 11 illustrates the beer tray 1010 acting as the product tray according to this embodiment. FIG. 12 illustrates a cross-sectional view of the beer tray 1010 shown in FIG. 11. As illustrated in FIG. 11, the beer tray 1010 according to this embodiment is the product holder 201 of the first embodiment shaped circularly. Such a feature allows the beer tray 1010 to easily hold a cylindrical product including, for example, a can and a bottle. Note that the beer as the product is an example. The product is not limited to beer but a beverage such as soda contained in a bottle and a can.

The battery 1002 in the power source 116 corresponds to a battery in the first embodiment. Examples of the battery 1002 include power sources such as a battery and a rechargeable battery. Moreover, the generator 1003 in the power source 116 is a power source generating power on, for example, light and pressure. Note that described in this embodiment is a case where the generator 1003 is, for example, a generating element generating power on vibration. The generator 1003 generates power when the beer tray 1010 receives vibration, for example, when a door of the storage container housing the beer tray 1010 opens.

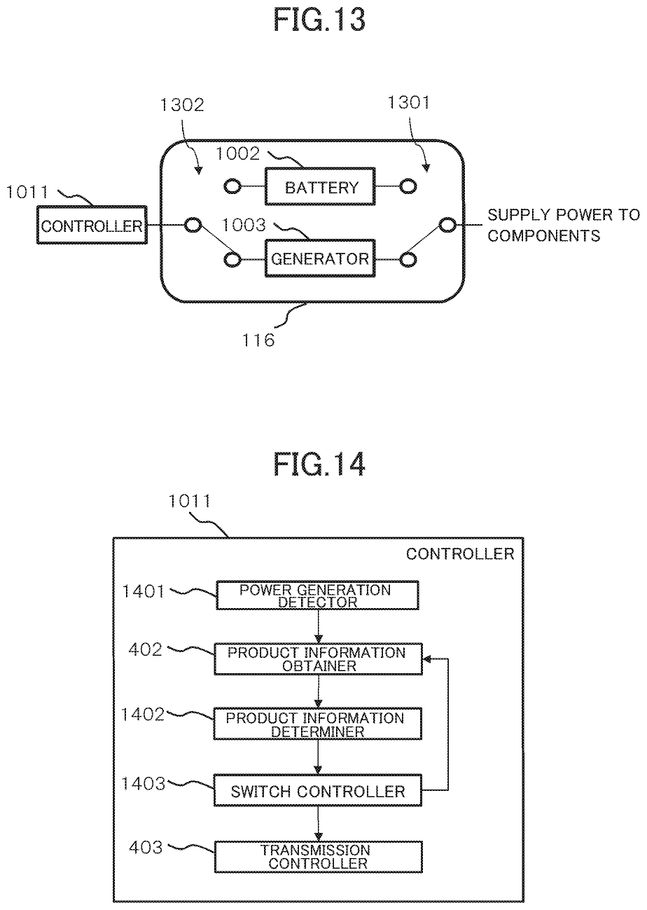

Moreover, as illustrated in FIG. 13, for example, the power source 116 according to this embodiment includes: a switch 1301; and a controller switch 1302, in addition to the battery 1002 and the generator 1003. The switch 1301 switches power supply sources, of components including the communications unit 113, between the battery 1002 and the generator 1003. The controller switch 1302 switches power supply sources, of the controller 1011, between the battery 1002 and the generator 1003. Note that described in this embodiment is a case where the switch 1301 and the controller switch 1302 are initially connected to the generator 1003.

FIG. 14 illustrates an example of a functional configuration of the controller 1011 of the beer tray 1010 shown in FIG. 10. As illustrated in FIG. 14, the controller 1011 according to this embodiment includes, for example: a power generation detector 1401; the product information obtainer 402; a product information determiner 1402; a switch controller 1403; and the transmission controller 403.

The power generation detector 1401 detects, for example, power generated by the generator 1003. Note that the power is generated by the generator 1003 when, for example, a door of a storage container such as a refrigerator is opened or closed. That is, the power generation by the generator 1003 is due to opening and closing of a door of a storage container such as a refrigerator. Hence, the detection of the power generation by this power generation detector 1401 is interpreted to correspond to door opening and closing information.

The product information obtainer 402 obtains, for example, the product information detected by the product sensor 115 as seen in the first embodiment.

The product information determiner 1402 determines, for example, whether the product information detected by the product sensor 115 is abnormal. Note that the abnormal product information indicates, for example, a case where the amount of power is short and the product information cannot be normally detected.

Based on the result of the determination made by the product information determiner 1402, for example, the switch controller 1403 switches between the battery 1002 and the generator 1003 destinations to which the switch 1301 and/or the controller switch 1302 are connected.

More specifically, for example, if the product information determiner 1402 determines that the product information is abnormal, the switch controller 1403 connects the switch 1301 and the controller switch 1302 to the battery 1002. That is, since the amount of power generated by the power generation detector 1003 is short, the switch controller 1403 connects the switch 1301 and the controller switch 1302 to the battery 1002 capable of supplying power. Then, the product information obtainer 402 obtains the product information again. Such a feature allows the battery 1002 to supply the power, making it possible to normally detect the product information.

Meanwhile, if, for example, the product information determiner 1402 determines that the product information is not abnormal but normal, the transmission controller 403 causes the communications unit 113 to transmit the product information as seen in the first embodiment. As a result, if the power generated by the generator 1003 is sufficient, the generator 1003 can cover the power for such components as the product sensor 115 and the communications unit 113, thereby reducing the power of the battery 1002 to be consumed. If the power generated by the generator 1003 is short, the battery 1002 covers the power so that normal product information can be transmitted.

Furthermore, for example, the switch controller 1403 may connect the controller switch 1302 to the battery 1002, based on the power generated by the generator 1003. Such a feature makes it possible to prevent or reduce the disruption of power supply to the controller 1011.

Moreover, based on the transmission of the product information by the transmission controller 403, for example, the switch controller 1402 switches between the battery 1002 and the generator 1003 destinations to which the switch 1301 and/or the controller switch 1302 are connected. More specifically, after the transmission of the product information, for example, the switch controller 1402 selects the generator 1003 as a destination to which the switch 1301 and the controller switch 1302 are connected.

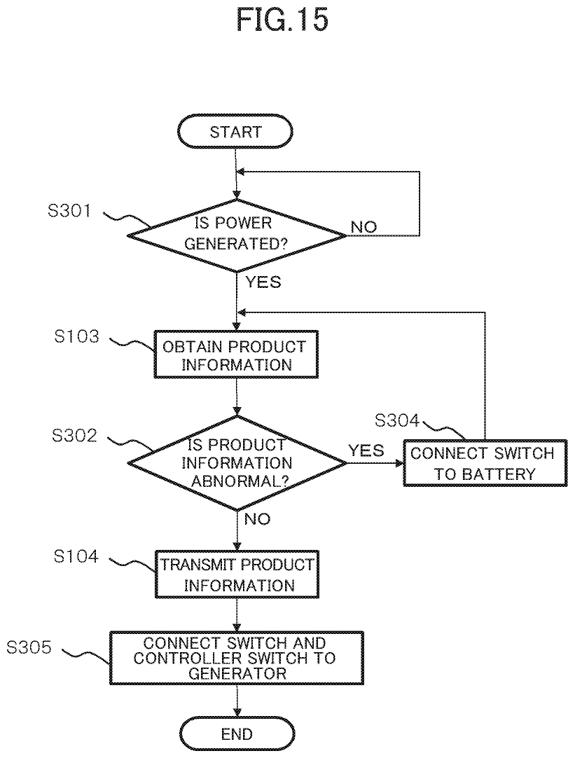

Described next is an example of a flow of processing executed in the beer tray according to this embodiment. FIG. 15 illustrates an example of a flow of processing executed in the beer tray according to this embodiment.

The power generation detector 1401 detects, for example, power generated by the generator 1003 (S301). If the power generation detector 1401 does not detect power (NO in S301), the processing returns to S301. If the power generation detector 1401 detects power (YES in S301), the product information obtainer 402 obtains product information (S103). The product information determiner 1402 determines whether the product information obtained is abnormal (S302). If the product information determiner 1402 determines that the product information is not abnormal (NO in S302), the transmission controller 403 causes the communications unit 113 to transmit the product information (S104). Such a feature allows the power generated by the generator 1003 to provide, for example, power for such components as the product sensor 115 and the communications unit 113, making it possible to reduce the power of the battery 1002 to be consumed.

Meanwhile, if the product information determiner 1402 determines in S302 that the product information is abnormal (YES in S302), the switch controller 1403 connects the switch 1301 to the battery 1002 (S304). The processing returns to S103. Such a feature ensures sufficient power to be supplied to components including the communications unit 113, making it possible to reduce communication failure and product information detection failure.

Furthermore, after the communications unit 113 transmits the product information, the switch controller 1403 connects the switch 1301 and the controller switch 1302 to the generator 1003 (S305). Such a feature makes it possible to newly prepare for power generation by the generator 1003.

Note that the flow of the processing executed in this embodiment shall not be limited to the above one. Alternatively, various modifications may be possible. For example, in S301, the power generation detector 1401 detects power generated by the generator 1003. Alternatively, the power generation detector 1401 may detect the amount of power generated by the generator 1003. Then, if the amount of power generated by the power generation detector 1401 is larger than or equal to a predetermined amount, the switch controller 1403 may connect the switch 1301 to the generator 1003. If the amount of power generated by the power generation. detector 1401 is smaller than the predetermined amount, the switch controller 1403 may connect the switch 1301 and the controller switch 1302 to the battery 1002. Such a feature makes it possible to efficiently use the power generated by the generator 1003. Moreover, the opening and closing of a door of a storage container such as a refrigerator may be determined not through the detection of power generated by the power generation detector 1401 but through activation of the controller 1011 on the power generated by the generator 1003.

According to this embodiment, power generation by the generator can supply power, making it possible to, for example, reduce power of the battery to be consumed. Such a feature contributes to delaying the time to replace the battery.

Moreover, the product sensor 115 may further include, for example, a temperature sensor. This temperature sensor detects, for example, a temperature of a canned beer; namely, the product 150 held in the product holder 201. Then, the temperature detected by this temperature sensor is included in the product information, and, for example, the temperature of the canned beer; namely, the product 150, is notified to the user. Such a feature makes it possible to notify the user of the right time to drink the beer, using, for example, a terminal apparatus.

Moreover, provided may be, for example, a battery level detector detecting a battery level of the battery 1002. When the battery level detected by the battery level detector falls lower than or equal to a predetermined level, the battery level may be notified to the user through a notifier. Such a feature makes it possible to notify the user of the time to replace the battery.

The present invention shall not be limited to the above embodiment. The configurations of the above embodiment may be replaced with substantially the same configuration; that is, the same advantageous effects or the same intention to achieve. While there have been described what are at present considered to be certain embodiments of the invention, it will be understood that various modifications may be made thereto, and it is intended that the appended claim cover all such modifications as fall within the true spirit and scope of the invention.

What is claimed is:

1. A product tray comprising:
a product holder configured to hold a product;
a product sensor configured to detect product information indicating a state of the product held in e product holder; and
a communications unit configured to transmit the product information, based on opening and closing of a door of a storage container housing the product tray.

2. The product tray according to claim 1, wherein
the communications unit transmits the product information if the door of the storage container is open.

3. The product tray according to claim 1, further comprising
a battery configured to supply power to the product sensor and the communications unit.

4. The product tray according to claim 1, further comprising
a door sensor configured to detect the opening and closing of the door of the storage container, wherein
the communications unit transmits the product information, based on information on the opening and closing of the door detected by the door sensor.

5. The product tray according to claim 1, further comprising
a generator configured to generate power by the opening and closing of the door of the storage container, wherein
the communications unit transmits the product information, based on detection of the power generated by the generator.

6. A refrigerator comprising:
the product tray according to claim 1;
wherein the storage container is the refrigerator.

7. A product tray system comprising:
the product tray according to claim 1;
a storage unit configured to store the product information transmitted from the product tray; and
a notifier configured to issue a notice, based on the product information.
